(19) United States
(12) Patent Application Publication
(10) Pub. No.: US 2013/0025784 A1
(43) Pub. Date: Jan. 31, 2013

(54) METHODS FOR MAKING AQUEOUS POLYURETHANE DISPERSIONS OF AROMATIC POLYISOCYANATE MIXTURES AND COMPOSITIONS

(71) Applicant: Henkel Corporation, Rocky Hill, CT (US)

(72) Inventors: Shuhui Qin, Bartlett, IL (US); Yingjie Li, Batavia, IL (US)

(73) Assignee: Henkel Corporation, Rocky Hill, CT (US)

(21) Appl. No.: 13/632,451

(22) Filed: Oct. 1, 2012

Related U.S. Application Data
(63) Continuation of application No. PCT/US2011/003043, filed on Mar. 30, 2011.
(60) Provisional application No. 61/320,087, filed on Apr. 1, 2010.

(51) Int. Cl. C08G 18/76; C08L 75/08; B05D 5/10; C09D 175/04; C09J 175/04; B32B 37/12; C08L 75/04; C08L 75/06

(52) U.S. Cl. 156/331.7; 524/591; 528/67; 427/207.1

(57) ABSTRACT

Aqueous polyurethane dispersions made from aromatic polyisocyanates and mixtures of aromatic polyisocyanates and compositions thereof are provided. Advantageously, the methods disclosed herein provide aqueous polyurethane dispersions which are produced more economically with no added organic solvent in the aqueous polyurethane dispersions. Such polyurethane dispersions are environmentally friendly and are useful as adhesives, sealants and coatings for laminating or bonding substrates such as paper, wood, metals, plastics and other synthetic materials.

### BACKGROUND

1. Field

Aqueous polyurethane dispersions of aromatic polyisocyanates and particularly making such dispersions from mixtures of aromatic polyisocyanates and compositions thereof are provided. In particular, the methods disclosed herein provide aqueous polyurethane dispersions which are produced more economically with no requirement for added organic solvent in the aqueous polyurethane dispersion. Such polyurethane dispersions are environmentally friendly and are useful as adhesives, sealants and coatings for laminating or bonding substrates such as paper, wood, metals, plastics and other natural and synthetic materials.

2. Brief Description Of Related Technology

A polyurethane dispersion is a colloidal system in which polyurethane particles are dispersed in a continuous aqueous medium or water/organic solvent mixture. Aqueous polyurethane dispersions are desirable in coating and adhesive applications as the amount of organic solvent is reduced which is not only more economical but is also beneficial as it reduces both occupational and environmental hazards associated with their use.

Currently, methods for making aqueous polyurethane dispersions of an aromatic polyisocyanate are problematic as such polymers are difficult to disperse in water without added organic solvent. Consequently, such dispersions require time-consuming processing steps and/or special equipment for their manufacture, each of which has its own disadvantages and limitations. For example, the acetone process utilizes an inert organic solvent to disperse the aromatic polymer in water followed by a distillation step to remove the organic solvent. Such an approach requires the use of a large amount of added organic solvent which can be hazardous and costly. Furthermore, despite the distillation step, the resultant dispersion still has a residual amount of organic solvent. Similarly, a melt dispersion process utilizes ammonia or urea to react the isocyanate-terminated polymer so as to increase its ability to disperse in water. However, further chain extension is often required and conducted using formaldehyde, a highly volatile and toxic agent. Alternatively, additional blocking reactions which seal off the reactive isocyanate groups may be employed. However, this approach not only increases the time and reagent costs associated with production but also limits the ability to produce polyurethane dispersions of high molecular weight. Yet another approach for producing such dispersions employs specialized equipment which requires significant capital expenditure. However, such specialized equipment is often of limited use, consequently this approach is cost-prohibitive.

Thus, there is a need for methods of making aqueous polyurethane dispersions of aromatic polyisocyanates based on mixtures of aromatic polyisocyanates which are more economical in terms of the time and cost associated with production thereof as well as the occupational and environmental hazards associated therewith. In addition, there is a need for aqueous polyurethane dispersions of an aromatic polyisocyanate wherein the aqueous polyurethane dispersions are free of added organic solvent.

### SUMMARY

The present invention provides methods of making polyurethane dispersions from an aromatic polyisocyanate which are more economical and reduce the hazards associated with their production. This invention also provides a method of making polyurethane dispersions made from a mixture of aromatic polyisocyanates. Desirably, methods of the present invention include the production of polyurethane dispersions from an aromatic polyisocyanates without the use of added organic solvent, the need for additional chemical reactions (e.g., blocking reactions) or specialized equipment.

In one aspect of the invention, there is provided methods of making a polyurethane dispersion from an aromatic polyisocyanate including: (1) forming a polyurethane prepolymer from a composition including: a) at least one polyol; b) at least one diol containing carboxyl functionality; c) an isomeric mixture of diphenylmethyl diisocyanate including about 37% by weight or less of 4,4′-methylene bis (phenyl isocyanate); and optionally, but desirably, d) at least one additional aromatic isocyanate and (2) combining the polyurethane prepolymer from step (1) with at least one neutralizing amine and water.

In another aspect of the invention, there is provided polyurethane prepolymers formed by reacting a composition including: a) at least one polyol; b) at least one diol containing carboxyl functionality; c) an isomeric mixture of diphenylmethyl diisocyanate including about 37% by weight or less of 4,4′-methylene bis (phenyl isocyanate); and optionally, but desirably, d) at least one additional aromatic isocyanate.

Additionally, in one aspect of the invention, there is provided polyurethane prepolymers formed from an isomeric mixture of diphenylmethyl diisocyanate including a polymer segment formed from no more than about 37% by weight 4,4′-methylene bis (phenyl isocyanate) isomer, and optionally, but desirably, at least one additional aromatic isocyanate.

In yet another aspect of the present invention, there is provided polyurethane dispersions including: a) an aqueous medium; and b) polyurethane prepolymer particles dispersed within the aqueous medium, wherein the polyurethane prepolymer particles are formed from a composition comprising an isomeric mixture of diphenylmethyl diisocyanate and optionally, but desirably, at least one additional aromatic isocyanate and the isomeric mixture includes no more than about 37% by weight of a polymer segment formed from 4,4′-methylene bis (phenyl isocyanate).

It is particularly desirable for certain embodiments that the “at least one additional aromatic isocyanate” be included in the process and compositions of the invention. For purposes of this invention, the “additional aromatic isocyanate” may also include another isomeric mixture of diphenylmethyl diisocycnate having a different percentage of 4,4′-methylene bis (phenyl isocyanate).

In one aspect of the invention, there is provided polyurethane coatings, adhesives and sealants formed from the polyurethane dispersions of the present invention.

In another aspect of the invention, there is provided methods of mating two substrates as well as methods of coating which include applying the polyurethane dispersions (PUDs) of the present invention thereto and allowing the polyurethane to cure or dry.

### DETAILED DESCRIPTION

Methods of the present invention provide a polyurethane prepolymer formulation of sufficiently low reactivity with water as well as low viscosity such that the resultant polyurethane is more readily dispersed in water. Though not meant to be limited to a particular mechanism, it is believed that a reduction in the amount of fast-reacting isocyanates, such as 4,4′-methylene bis (phenyl isocyanate), results in a reduction in the reactivity of the polyurethane prepolymer with water as well as a concomitant reduction in the viscosity of the polyurethane prepolymer. Moreover, it has also unexpectedly been found that a composition including an isomeric mixture of diphenylmethyl diisocyanate, having no more than about 37% by weight of a polymer segment formed from 4,4′-methylene bis (phenyl isocyanate), in combination with at least one additional aromatic isocyanate allows for the use of less of the isomeric mixture of diphenylmethyl diisocyanate, the latter being difficult to find commercially and requiring added expense to prepare.

Methods of making polyurethane dispersions from the inventive mixtures of aromatic isocyanates in accordance with the present invention provide aqueous polyurethane dispersions that do not require added organic solvent, use of specialized dispersion equipment, or chemical blocking reactions. Nonetheless, the methods provided herein are compatible with the use of added organic solvent, specialized dispersion equipment or chemical blocking reactions and may include one or more of these approaches for the formation of polyurethane dispersions from an aromatic polyisocyanate. Likewise, such methods do not require, but may include, special processing (e.g., flash evaporation), addition of a chain extender, or use of ammonia, urea, formaldehyde, ketimines and ketazines. Desirably, the polyurethane dispersions of the present invention remain a homogeneous polyurethane dispersion, rather than a gel, for a commercially viable period of time.

As used herein, the phrase “free of added organic solvent” with reference to methods of making polyurethane dispersions in accordance with the present invention, refers to the lack of a step wherein a carbon-containing chemical solvent is added to the polyurethane prepolymer to produce a polyurethane dispersion. It is understood that the components used in forming a polyurethane dispersion in accordance with the present invention may include an organic solvent therein. However, the presence of an organic solvent in such components is not considered an added organic solvent in accordance with the methods of the present invention.

As used herein, the term “mating” with regard to two substrates refers to adhering one or more surfaces of a first substrate with one or more surfaces of a second substrate using the polyurethane dispersions of the present invention.

### Methods of Making Polyurethane Dispersions

In one aspect of the present invention, provided are methods of making a polyurethane dispersion from an aromatic polyisocyanate including: (1) forming a polyurethane prepolymer from a composition including: a) at least one polyol; b) at least one other polyol which is a diol containing carboxyl functionality; c) an isomeric mixture of diphenylmethyl diisocyanate including about 37% by weight or less of 4,4′-methylene his (phenyl isocyanate); and optionally, but desirably, d) at least one additional aromatic isocyanate; and (2) combining the polyurethane prepolymer from step (1) with at least one neutralizing amine and water.

In certain embodiments, methods of making a polyurethane dispersion optionally include the addition of one or more additives which may be non-reactive or reactive and are desirably compatible with components of the polyurethane dispersion. Such additives are known to the person skilled in the art. Exemplary additives include, but are not limited to, polymer emulsions, surfactants, antifoam or defoam agents, thickeners, film forming aides, plasticizer oils, colorants, fillers, UV dyes, rheology modifiers, tackifiers, antioxidants, silanes, UV barriers, stabilizers, adhesion promoters, flame retardants, conductive agents, waxes, solvents, chain stoppers, blocking agents, ketimines and ketazines. Specific examples include, but are not limited to defoamer agents commercially available from Munzing Chemie, Bloomfield, N.J., including DeeFo 3000.

The polyurethane dispersions of the present invention may be used as a multi-component system (e.g., a 2-component system). Exemplary additional components include, but are not limited to, one or more other polyisocyanates, epoxy resins, aziridines, carbodiimides, urea-formaldehydes as well as other chemicals which can react with the polyurethane dispersion.

In one aspect of the present invention, there is provided methods of making polyurethane dispersions which further include blending the polyurethane prepolymer formed with a monomer, a polymer, or any combination thereof.

In another aspect of the present invention, there is provided methods of making polyurethane dispersions which further include copolymerizing the polyurethane prepolymer formed with a monomer, a polymer, or any combination thereof. Exemplary components for copolymerization with the polyurethane dispersion include, but are not limited to, acrylic polymers. Notably, post-dispersion chemical linkage such as post-dispersion grafting of other polymers to the polyurethane dispersion may also be employed.

In certain embodiments, the methods of making a polyurethane dispersion from an aromatic polyisocyanate further include adding at least one additive to one or more of step (1) or step (2) described above.

In certain embodiments, the methods of making a polyurethane dispersion from an aromatic polyisocyanate further include adding at least one amine crosslinker in step (2) described above. Exemplary amine crosslinkers include, but are not limited to, ethylene diamine (EDA, 99%; commercially available from Sigma-Aldrich, St. Louis, Mich.).

In one embodiment, methods for making a polyurethane dispersion are provided which include reacting an excess amount of polyisocyanate with a polyol, at least one other polyol which is a diol containing a carboxylic group, and optionally a chain extender to form a prepolymer preparation.

In certain embodiments, a chain extender is added during the dispersion step. Exemplary chain extenders include, but are not limited to, hydrazine and ethylene diamine.

In certain embodiments, the methods of making a polyurethane dispersion from an aromatic polyisocyanate are free of added organic solvent. Such polyurethane dispersions are thereby produced by a so-called “solvent-free” process.

In certain other embodiments, methods for making a polyurethane dispersion containing an aromatic isocyanate are provided which include an added organic solvent. Likewise, in certain embodiments, the polyurethane dispersions of the present invention further include an added organic solvent in which polyurethane is dispersed. It should be noted that addition of an organic solvent to the polyurethane prepolymer can facilitate formation of the polyurethane dispersion. Generally, even though certain embodiments of the present invention may include added organic solvent, the amount of added organic solvent used is reduced relative to an amount that would otherwise be required using conventional methods for making such polyurethane dispersions.

In certain embodiments, specialized equipment for forming polyurethane dispersions of the present invention, though not required, may be used as well. In certain embodiments, such specialized equipment facilitates the formation of polyurethane dispersions containing an aromatic isocyanate in an aqueous medium wherein the polyurethane dispersions are free of added organic solvent.

In certain embodiments, methods for making the polyurethane dispersions of the present invention include additional chemical reactions, such as blocking reactions, to reduce the reactivity of prepolymer preparation with water. In certain embodiments, methods for making a polyurethane dispersion containing an aromatic isocyanate are provided which further include chemical reactions to block the reactive isocyanate groups.

### Polyol

In certain embodiments, at least one polyol is a polyether polyol, a polyester polyol, an acrylic polyol, or a polybutadiene polyol. Combinations of such polyols may also be employed.

Polyether polyols suitable for use in the present invention, include but are not limited to, polyethylene glycol, polypropylene glycol, polyethylene end-capped polypropylene glycol, polytetramethylene glycol having an average molecular weight of about 200 to about 18,000. Such polyether polyols suitable for use in the present invention are generally commercially available from Bayer, Leverkusen, Germany; Huntsman, Woodlands, Tex.; Dow Chemical Company, Midland, Mich. and BASF, Ludwigshafen, Germany. For example, a polyether polyol having an average molecular weight of about 2000 such as PPG 2000 (commercially available from Bayer, Leverkusen, Germany) may be used. In certain embodiments, the amount of polyether polyol is in the range of about 0% to about 90% by weight of the composition from which the polyurethane prepolymer is formed.

Polyester polyols suitable for use in the present invention include crystalline polyester polyols, liquid polyester polyols, amorphous polyester polyols/and combinations thereof. Such polyester polyols suitable for use in the present invention are generally commercially available from Evonik Industries, Essen, Germany; Panolam Industries, Shelton, Conn.; Bayer, Leverkusen, Germany; and Chemtura, Middlebury, Conn. For example, a polyester polyol having an average molecular weight of about 2000 such as Desmophen S-105-55) (commercially available from Bayer, Leverkusen, Germany) may be used. In certain embodiments, the amount of polyester polyol is in the range of about 0% to about 90% by weight of the composition from which the polyurethane prepolymer is formed.

Notably, at least one other polyol is a diol containing carboxyl functionality. Exemplary diols containing carboxyl functionality, include but are not limited to, 2,2-dimethylolpropionic acid (DMPA) and 2,2-dimethylolbutanic acid. DMPA is a small molecular weight diol containing carboxylic group (commercially available from GEO Specialty Chemicals, Cleveland, Ohio).

In certain embodiments, the polyol is present in an amount of about 50% to about 95% by weight of the composition from which the polyurethane prepolymer is formed.

In certain embodiments, the diol containing carboxyl functionality is present in an amount of about 1% to about 25% by weight of the composition from which the polyurethane prepolymer is formed.

### Polyisocyanate

Polyisocyanates for use in the present invention include mixtures of diphenylmethyl diisocyanate having about 37% by weight or less of 4,4′-methylene bis (phenyl isocyanate) and optionally, but desirably, at least one additional aromatic isocyanate. In certain embodiments, the polyisocyanate is a mixture of diphenyl aromatic isocyanates having about 33% by weight or less of 4,4′-methylene bis (phenyl isocyanate) and optionally, but desirably, at least one additional aromatic isocyanate. In certain embodiments, the polyisocyanate is a mixture of diphenyl aromatic isocyanates having about 20% by weight or less of 4,4′-methylene bis (phenyl isocyanate) and optionally, but desirably, at least additional aromatic isocyanate In certain embodiments, the polyisocyanate is a mixture of diphenyl aromatic isocyanates having about 12% by weight or less of 4,4′-methylene bis (phenyl isocyanate) and optionally, but desirably, at least additional aromatic isocyanate. In certain embodiments, the polyisocyanate is a mixture of diphenylmethyl diisocyanate having about 9% by weight or less of 4,4′-methylene bis (phenyl isocyanate). In certain embodiments, the polyisocyanate is a mixture of diphenylmethyl diisocyanate having about 6% by weight or less of 4,4′-methylene bis (phenyl isocyanate) and optionally, but desirably, at least one additional aromatic isocyanate. In certain embodiments, the polyisocyanate is a mixture of diphenylmethyl diisocyanate having about 3% by weight or less of 4,4′-methylene bis (phenyl isocyanate) and optionally, but desirably, at least one additional aromatic isocyanate. In certain embodiments, the polyisocyanate is a mixture of diphenylmethyl diisocyanate having about 2% by weight or less of 4,4′-methylene bis (phenyl isocyanate) and optionally, but desirably, at least one additional aromatic isocyanate.

In certain embodiments, the functionality of the polyisocyanate is from about 1.1 to about 3.5. In certain embodiments, the functionality of the polyisocyanate is from about 1.5 to about 3. In certain embodiments, the functionality of the polyisocyanate is from about 1.8 to about 2.3.

Exemplary diphenylmethyl polyisocyanates suitable for the isomeric mixture in the present invention, include but are not limited to, polyisocyanate having 4,4′-methylene his (phenyl isocyanate) content equal or less than 1.75% by weight of the polyisocyanate (available under the trade name Lupranat MCI, commercially available from Elastogran/BASF, Ludwigshafen, Germany) and polyisocyanate having 4,4′-methylene bis (phenyl isocyanate) content equal or less than 1.5% by weight of the polyisocyanate (available under the trade name Desmodur 24 MI, commercially available from Bayer, Leverkusen, Germany).

Additional aromatic isocyanates used in combination with the aforementioned isomeric mixtures include any aromatic isocyanate compatible with the reaction. For example, among the useful ones include, without limitation, Mondur M, (available from Bayer) a mixture of isomers of dephenylmethane diisocyanate (MDI) with 4,4′-MDI content of 98% by weight or higher; Mondur ML (available from Bayer), a mixture of isomers of MDI with 4,4′-MDI content of about 45% by weight; Mondur TD80 (available from Bayer) a mixture of isomers of toluene diisocyanate (TDI) with 80% by weight 2,4′-TDI and 20% 2,6′-TDI; Mondur TD (available from Bayer), 65%/35% by weight mixture of 2,4′- and 2,6′-TDI respectively; and Mondur TDS (available from Bayer), >98% by weight 2,4′-TDI.

In certain embodiments, the amount of total polyisocyanate, including the isomeric mixture and the optional additional aromatic isocyanate, is present in an amount from about 3% to about 60% by weight of the composition from which the polyurethane prepolymer is formed. In certain embodiments, the amount of total polyisocyanate is present in an amount from about 5% to about 50% by weight of the composition from which the polyurethane prepolymer is formed. In certain embodiments, the amount of polyisocyanate is present in an amount from about 10% to about 40% by weight of the composition from which the polyurethane prepolymer is formed.

It has been discovered the combination of the isomeric mixture in combination with another aromatic isocyanate has distinct advantages over prior methods for making polyurethane dispersions. Because the isomeric mixture may be costly and/or labor intensive to make or obtain, the addition of another aromatic isocyanate allows the ability to use less of the isomeric mixture to achieve the same end products. It has surprisingly been discovered that the isomeric mixture and the additional isocyanate can be added together with one or more polyols in an essentially one step process and still achieve a stable polyurethane dispersion with minimal gel formation. By “one-step process” is meant that if the isomeric isocyanate mixture is added first with the polyol(s), then the additional aromatic isocyanate should be added within 45 minutes after the isomeric mixture starts to react with the polyol(s) in the temperature range of about 60° to about 90°. Similarly, if the additional aromatic isocyanate is added to the polyol(s) first, then the isomeric mixture of isocyanates should be added within 45 minutes after the additional aromatic isocyanate starts to react with the polyol(s).

### Neutralizing Amine

In certain embodiments, the neutralizing amine is present in a ratio of diol containing carboxyl functionality to neutralizing amine of about 1:0.35 to about 1:2.5. In certain embodiments, the neutralizing amine is present in a ratio of diol containing carboxyl functionality to neutralizing amine of about 1:1.

Exemplary neutralizing amine include, but are not limited to, triethylamine (TEA, 99%, commercially available from Alfa Aesar, Ward Hill, Mass.).

### Polyurethane Prepolymers

In another aspect of the present invention, there is provided polyurethane prepolymers formed by reacting a composition including: a) at least one polyol; b) at least one other polyol which is a diol containing carboxyl functionality; c) an isomeric mixture of diphenylmethyl diisocyanate including about 37% by weight or less of 4,4′-methylene his (phenyl isocyanate); and d) optionally, but desirably, at least one additional aromatic isocyanate. In some embodiments, the isomeric mixture of diphenylmethyl diisocyanate includes about 33% by weight or less 4,4′-methylene his (phenyl isocyanate). In some embodiments, the isomeric mixture of diphenylmethyl diisocyanate includes about 20% by weight or less 4,4′-methylene his (phenyl isocyanate). In some embodiments, the isomeric mixture of diphenylmethyl diisocyanate includes about 12% by weight or less 4,4′-methylene bis (phenyl isocyanate). In another embodiment, the isomeric mixture of diphenylmethyl diisocyanate includes about 9% by weight or less of 4,4′-methylene bis (phenyl isocyanate). In another embodiment, the isomeric mixture of diphenylmethyl diisocyanate includes about 6% by weight or less of 4,4′-methylene bis (phenyl isocyanate). In yet another embodiment, the isomeric mixture of diphenylmethyl diisocyanate includes about 3% by weight or less of 4,4′-methylene his (phenyl isocyanate). In still yet another embodiment, the isomeric mixture of diphenylmethyl diisocyanate includes about 2% by weight or less of 4,4′-methylene bis (phenyl isocyanate). Each of the aforementioned isomeric mixture embodiments optionally, but desirably, include an additional aromatic isocyanate.

Additionally, in one aspect of the invention, there is provided polyurethane prepolymers formed from an isomeric mixture of diphenylmethyl diisocyanate including a polymer segment formed from no more than about 37% by weight 4,4′-methylene bis (phenyl isocyanate) isomer and optionally, but desirably, at least one additional aromatic isocyanate. In one embodiment, the isomeric mixture of diphenylmethyl diisocyanate includes about 33% by weight or less of 4,4′-methylene bis (phenyl isocyanate) and optionally, but desirably, at least one additional aromatic isocyanate. In yet another embodiment, the isomeric mixture of diphenylmethyl diisocyanate includes about 20% by weight or less of 4,4′-methylene bis (phenyl isocyanate) and optionally, but desirably, at least one additional aromatic isocyanate. In some embodiments, the isomeric mixture of diphenylmethyl diisocyanate includes about 12% by weight or less of 4,4′-methylene bis (phenyl isocyanate) and optionally, but desirably, at least one additional aromatic isocyanate. In one embodiment, the isomeric mixture of diphenylmethyl diisocyanate includes about 9% by weight or less of 4,4′-methylene bis (phenyl isocyanate) and optionally, but desirably, at least one additional aromatic isocyanate. In another embodiment, the isomeric mixture of diphenylmethyl diisocyanate includes about 6% by weight or less of 4,4′-methylene bis (phenyl isocyanate) and optionally, but desirably, at least one additional aromatic isocyanate. In yet another embodiment, the isomeric mixture of diphenylmethyl diisocyanate includes about 3% by weight or less of 4,4′-methylene bis (phenyl isocyanate) and optionally, but desirably, at least one additional aromatic isocyanate. In still yet another embodiment, the isomeric mixture of diphenylmethyl diisocyanate includes about 2% by weight or less of 4,4′-methylene bis (phenyl isocyanate) and optionally, but desirably, at least one additional aromatic isocyanate.

In yet another aspect of the present invention, there is provided polyurethane dispersions including: a) an aqueous medium; and b) polyurethane prepolymer particles dispersed within the aqueous medium, the polyurethane prepolymer particles are formed from a composition including an isomeric mixture of diphenylmethyl diisocyanate and optionally, but desirably, at least one additional aromatic isocyanate; and the isomeric mixture includes no more than about 37% by weight of a polymer segment formed from 4,4′-methylene bis (phenyl isocyanate). In another embodiment, the isomeric mixture includes no more than about 33% by weight of a polymer segment formed from 4,4′-methylene bis (phenyl isocyanate). In another embodiment, the isomeric mixture includes no more than about 20% by weight of a polymer segment formed from 4,4′-methylene bis (phenyl isocyanate). In another embodiment, the isomeric mixture includes no more than about 12% by weight of a polymer segment formed from 4,4′-methylene bis (phenyl isocyanate). In one embodiment, the isomeric mixture of diphenylmethyl diisocyanate includes about 9% by weight or less of 4,4′-methylene bis (phenyl isocyanate). In another embodiment, the isomeric mixture of diphenylmethyl diisocyanate includes about 6% by weight or less of 4,4′-methylene bis (phenyl isocyanate). In yet another embodiment, the isomeric mixture of diphenylmethyl diisocyanate includes about 3% by weight or less of 4,4′-methylene bis (phenyl isocyanate). In still yet another embodiment, the isomeric mixture of diphenylmethyl diisocyanate includes about 2% by weight or less of 4,4′-methylene bis (phenyl isocyanate). The additional aromatic isocyanate optionally, but desirably used in the above dispersion embodiments may be selected from any suitable aromatic isocyanate, and particularly those recited herein.

### Uses of Polyurethane Dispersions

Polyurethane dispersions of the present invention are useful as adhesives, sealants and coatings for laminating or bonding substrates such as paper, wood, metals, plastics and other synthetic materials.

In one aspect of the invention, there is provided polyurethane coatings, formed from the polyurethane dispersions of the present invention.

In another aspect of the invention, there is provided adhesives formed from the polyurethane dispersions of the present invention.

In yet another aspect of the invention, there is provided sealants formed from the polyurethane dispersions of the present invention.

In still another aspect of the invention, there is provided methods of mating two substrates including applying a polyurethane dispersion of the present invention to a substrate surface, mating another substrate therewith such that the polyurethane dispersion is in contact with both substrates and allowing the polyurethane dispersion to cure or dry.

Additionally, in another aspect of the invention, there is provided methods of coating including applying the polyurethane dispersion of the present invention to a substrate and allowing it to dry.

Likewise, in another aspect of the invention, there is provided methods of coating including applying a polyurethane dispersion of the present invention to a substrate and allowing it to cure.

The invention may be further understood with reference to the following non-limiting examples.

### EXAMPLES

### Preparation of Polyurethane Prepolymers

Inventive Prepolymer Formulation A and Comparative Prepolymer Formulations B and C were prepared in accordance with the components and amounts (i.e., % weight) as provided in Table 1, below.

TABLE 1

| | Inventive | Comparative | Comparative |
|---|---|---|---|
| | Prepolymer | Prepolymer | Prepolymer |
| Component | Formulation A | Formulation B | Formulation C |
| Desmsophen S1015-55 | 60.03 | 60.03 | 60.03 |
| DMPA | 6.6 | 6.6 | 6.6 |
| Lupranat MCI | 33.37 | — | — |
| Mondur ML | — | 33.37 | — |
| Mondur M | — | — | 33.37 |

In brief, Desmophen S1015-55 and DMPA were added to a mixer reactor and heated with agitation up to 60° C. After the DMPA completely dissolved, the respective diphenylmethyl diisocyanate (i.e., Lupranat MCI, Mondur ML, or Mondur M) was added to the mixture and observed for exotherm. After exotherm was no longer observed, the mixer reactor temperature was increased to 90° C. and kept stable at that temperature during the reaction. The reaction was stopped when the NCO % reached the desired value. The prepolymer was cooled down to 70° C. for formation of the polyurethane dispersion.

Notably, although the amount of isomeric mixture of diphenylmethyl diisocyanate added (i.e., 33.37% weight) was equal for both Inventive Prepolymer Formulation A and Comparative Prepolymer Formulations B and C, different amounts of 4,4′-diphenylmethyl diisocyanate were present in each isomeric mixture of diphenylmethyl diisocyanate added. Lupranat MCI having 4,4′-methylene his (phenyl isocyanate) content of about 2% by weight of the polyisocyanate, with Mondur ML and Mondur M (both of which are commercially available from Bayer, Leverkusen, Germany) having 4,4′-methylene his (phenyl isocyanate) content of about 45% and 98% by weight of the polyisocyanate, respectively. More specifically, Lupranat MCI is about 98% 2,4′ methylene bis (phenyl isocyanate), about 2% 4,4′-methylene his (phenyl isocyanate), and a miniscule amount of 2,2′ methylene his (phenyl isocyanate). In contrast, Mondur ML is about 55% 2,4′ methylene bis (phenyl isocyanate), about 45% 4,4′-methylene his (phenyl isocyanate), and about 2% 2,2′ methylene his (phenyl isocyanate) and Mondur M is at least 98% 4,4′-methylene his (phenyl isocyanate) with the remaining portion of polyisocyanate being a mixture of the other two isomeric forms 2,4′ methylene bis (phenyl isocyanate) and 2,2′ methylene his (phenyl isocyanate).

### Examination of Properties of Prepolymer Formulations

The viscosity at 90° C. as well as the % NCO content of each of the prepolymer formulations detailed in Table 1 was examined, the results of which are summarized in Table 2.

TABLE 2

| | Inventive | Comparative | Comparative |
|---|---|---|---|
| | Prepolymer | Prepolymer | Prepolymer |
| Property | Formulation A | Formulation B | Formulation C |
| Viscosity (cps) at | 4900 | 9125 | 13500 |
| 90° C. | | | |
| % NCO | 4.6% | 4.5% | 4.5% |

Notably, although the % NCO content was similar (i.e., about 4.5%) between all three prepolymer formulations, the viscosity at 90° C. of Inventive Prepolymer Formulation A was significantly less than either Comparative Prepolymer Formulation B or C. Specifically, the viscosity at 90° C. of Inventive Prepolymer Formulation A was 4900 cps while Comparative Prepolymer Formulation B was almost double that at 9125 cps and Comparative Prepolymer Formulation C was almost even triple that at 13500 cps, respectively.

### Preparation of Polyurethane Dispersions

The aforementioned polyurethane prepolymers were used to prepare the polyurethane dispersion compositions detailed in Table 3. In brief, (step I) triethylamine (TEA) was added to the mixer reactor containing polyurethane prepolymer under agitation, and allowed to mix for 10 minutes with the prepolymer. Thereafter, (step II) distilled water (DI water) was added and the agitation rate increased to 7000 rpm with defoaming agent (e.g., DeeFo 3000) added as needed to control foaming during the dispersion. Following one hour, ethylene diamine (EDA), available from Sigma Aldrich, pre-dissolved in DI water was added to the dispersion under agitation. The ethylene diamine thereby functioned as a cross-linker to eliminate free NCO. The agitation was stopped when no residual % NCO was detected by IR analysis, at which point the materials in mixer reactor were collected.

TABLE 3

| | | Inventive | Comparative | Comparative |
|---|---|---|---|---|
| | | Dispersion | Dispersion | Dispersion |
| Step | Component | Composition D | Composition E | Composition F |
| I | Prepolymer A | 34.73 | — | — |
| | Prepolymer B | — | 34.73 | — |
| | Prepolymer C | — | — | 34.73 |
| | TEA | 1.72 | 1.72 | 1.72 |
| | DI Water | 60.68 | 60.68 | 60.68 |
| | DeeFo 3000 | 0.05 | 0.05 | 0.05 |
| II | DI Water | 1.88 | 1.88 | 1.88 |
| | EDA | 0.94 | 0.94 | 0.94 |

The sole variable between the dispersion compositions detailed in Table 3 is the prepolymer used in its formation. Each prepolymer having a different amount of 4,4′-diphenylmethyl diisocyanate present in the isomeric mixture of diphenylmethyl diisocyanate employed in its formation. Namely, Prepolymers A, B and C having 4,4′-methylene bis (phenyl isocyanate) content of about 2%, about 45% and at least 98%, respectively, by weight of the polyisocyanate diphenylmethyl diisocyanate.

### Examination of Physical Properties of Polyurethane Dispersions

The solid content present in a filtrate of the polyurethane dispersion compositions detailed in Table 3 were examined following a specified time period. In brief, within 1 day of manufacture as well as following 5 days after manufacture, the polyurethane dispersions were filtered through a 100 μm filter bag to remove any gelled portion or larger particles after which the solid content of the filtrate was measured. In addition, as a point of comparison, the solid content for each dispersion composition was calculated based on the components thereof. The percentage of solid contents measured in the polyurethane dispersions as well as that calculated are summarized in Table 4 below.

TABLE 4

| | Inventive | Comparative | Comparative |
|---|---|---|---|
| | Dispersion | Dispersion | Dispersion |
| Property | Composition D | Composition E | Composition F |
| 0 days after made | Homogeneous | Homogeneous | Partial gel |
| | polymeric | polymeric | |
| | dispersion | dispersion | |
| 5 days after made | Homogeneous | Partial gel | Gel |
| | polymeric | | |
| | dispersion | | |
| Calculated solid | 35.7 | 35.7 | 35.7 |
| content (% weight) | | | |
| Measured solid | 35 | 29.2 | 0.3 |
| content in filtrate (% | | | |
| weight) after 5 days | | | |

Surprisingly, Inventive Dispersion Composition D, which contained no added organic solvent, remained a homogeneous polymer dispersion even after 5 days storage following its manufacture. In contrast, although Comparative Dispersion Composition E was observed to be a homogeneous polymeric dispersion initially, it was a partial gel within 5 days storage following its manufacture. Moreover, Comparative Dispersion Composition F was already a partial gel within less than a day of its manufacture and fully gelled within 5 days storage following its manufacture. Additionally, comparisons of the calculated amount of solid content in the dispersion with the measured solid content in filtrate after 5 days storage following manufacture thereof supported the aforementioned physical observations. In particular, the calculated amount of solid content in the dispersion of Inventive Dispersion Composition D was within 1% by weight of the measured solid content in filtrate after 5 days storage following manufacture thereof. In contrast, the calculated amount of solid content in the dispersion of Comparative Dispersion Composition E and F was greater than 6% by weight and 35% by weight, respectively, of the measured solid content in filtrate after 5 days storage following manufacture thereof. In other words, greater than 6% by weight and 35% by weight of the Comparative Dispersions E and F, respectively, formed a gel or a precipitate. This disparity in the calculated and measured amount of solid content in Comparative Dispersion Compositions E and F reflects a loss of solid matter in the dispersion following filtration thereof and indicates that a significant portion of solid matter had settled out of the dispersion.

Tables 5-7 provide inventive compositions G-J, L-Q and R, which contain the isomeric mixture of MDI having about 37% or less by weight of 4,4′-methylene bis (phenyl isocyanate) (e.g. Lupranat MCI) and an additional aromatic diisocyanate; (e.g. Mondur M, ML, TD-80) as well as comparative example K, which did not include the inventive isomeric mixture.

TABLE 5
Inventive Compositions for Polyurethane Prepolymer by
a One-Step Process

| | Sample | | | | |
|---|---|---|---|---|---|
| | | | | | K |
| | G | H | I | J | (comparative) |
| Desmophen S1015-55 | 180.2 | 180.2 | 180.2 | 180.2 | 180.2 |
| DMPA | 19.8 | 19.8 | 19.8 | 19.8 | 19.8 |
| Mondur M | 33.3 | | | | |
| Mondur ML | | 66.6 | | | 66.6 |
| Mondur TD-80 | | | 22.5 | 45 | 22.5 |
| Lupranat MCI | 66.6 | 33.3 | 66.6 | 33.3 | |
| Desmodur I | | | | | |
| DBTDL | | | | | |

Prepolymers Preparation: One-step process: All the prepolymers list in Table 5 were prepared using the method described below with only the relative amounts and specific types of reactants changed for each example. Desmophen S1015-55 and DMPA were added to a mixer reactor and heated with agitation up to 60° C. After the DMPA was completely dissolved, two aromatic isocyanates were added to the mixture at the same time or one immediately after the other. When there is no exotherm, the mixer reactor temperature was stable at 75° C. during the reaction. The reaction was stopped when the NCO % reached the desired value. Then, the prepolymers were ready for dispersion.

TABLE 6
Inventive Compositions for Polyurethane
Prepolymer by a Two-Step Process

| | Sample | | | | | |
|---|---|---|---|---|---|---|
| | L | M | N | O | P | Q |
| Desmophen S1015-55 | 180.2 | 204 | 227.4 | 229.5 | 180.2 | 180.2 |
| DMPA | 19.8 | 19.8 | 9.6 | 7.5 | 19.8 | 19.8 |
| Mondur M | 33.3 | 25.5 | 21 | 21 | — | — |
| Mondur ML | — | — | — | — | 33.3 | — |
| Mondur TD-80 | — | — | — | — | — | 22.5 |
| Lupranat MCI | 66.6 | 51 | 42 | 42 | 66.6 | 66.6 |
| Desmodur I | — | — | — | — | — | — |
| DBTDL | — | — | — | — | — | — |

Two-step process: All the prepolymers listed in table 6 were prepared using the method described below with only the relative amounts and specific types of reactants changed for each example. Desmophen S1015-55 and DMPA were added to a mixer reactor and heated with agitation up to 60° C. After the DMPA was completely dissolved, the aromatic diisocyanate (Mondur ML) was added to the mixture. When there was no exotherm, the mixer reactor temperature was kept stable at 75° C. during the reaction. After 2 hours for Mondur M, 3 hours for Mondur TD-80 and 4 hours for Mondur ML, Lupranat MCI (inventive isomeric mixture of diiphenylmethyl diisocyanate with about 37% or less 4,4′-methylene bis (phenyl isocyanate)) was added to the mixture and continued to react at 75° C. The reaction was stopped when the NCO % reached the desired value. Then, the prepolymers were ready for dispersion.

TABLE 7
Inventive Compositions for Polyurethane Prepolymer by
Reverse Two-Step Process

| | Sample |
|---|---|
| | R |
| Desmophen S1015-55 | 180.2 |
| DMPA | 19.8 |
| Mondur M | |
| Mondur ML | 66.6 |
| Lupranat MCI | 33.3 |
| Mondur TD-80 | |
| Desmodur I | |
| DBTDL | |

Reverse two-step process: The prepolymer listed in Table 7 was prepared by a “reverse two-step” process. Desmophen S1015-55 and DMPA are added to a mixer reactor and heated with agitation up to 60° C. After the DMPA has been completely dissolved. The isomeric isocyanate mixture (Lupranat MCI in this case) was added to the mixture. When there was no exotherm, the mixer reactor temperature was kept stable at 75° C. for 2 hours. Then, the additional aromatic isocyanate, (Mondur ML in this case) was added to the mixture and continued to react at 75° C. The reaction was stopped when the NCO % reached the desired value. Then, the prepolymers were ready for dispersion.

TABLE 8
Prior Art: Compositions for Polyurethane
Prepolymer by One-Step Process

| | Sample | | | | | |
|---|---|---|---|---|---|---|
| | S | T | U | V | W | X |
| Desmophen | 195.5 | 211.2 | | 180.2 | | 180.2 |
| S1015-55 | | | | | | |
| PPG 2000 | | | 211.2 | | 219.6 | |
| DMPA | 21.6 | 16.8 | 16.8 | 19.8 | 18 | 19.8 |
| Mondur M | 40.95 | 36 | 36 | 33.3 | | |
| Mondur ML | | | | | | 66.6 |
| Lupranat MCI | | | | | | |
| Mondur TD-80 | | | | | 31.2 | |
| Desmodur I | 40.95 | 36 | 36 | 59.3 | 31.2 | 29.6 |
| DBTDL | 0.02 | 0.02 | 0.02 | 0.02 | 0.02 | 0.02 |

Tables 8 and 9 provide compositions which do not include the isomeric mixture of diphenylmethyl diisocyanate having about 37% or less 4,4′-methylene bis (phenyl isocyanate).

Prior art by one-step process: All the prepolymers list in Table 8 were prepared using the method described below with only the relative amounts and specific types of reactants changed for each example. Desmophen S1015-55 (or PPG2000) and DMPA are added to a mixer reactor and heated with agitation up to 60° C. After the DMPA has been completely dissolved, two isocyanates and DBTDL are added to the mixture. When there was no exotherm, the mixer reactor temperature was kept stable at 75° during the reaction. The reaction is stopped when the NCO % reaches the desired value. Then, the prepolymers were ready for dispersion.

TABLE 9
Prior Art: Compositions for Polyurethane
Prepolymer by Two-Step Process

| | Sample | | |
|---|---|---|---|
| | Y | Z | ZZ |
| Desmophen S1015-55 | 195.5 | 216 | |
| PPG 2000 | | | 211.2 |
| DMPA | 21.6 | 15 | 16.8 |
| Mondur M | 40.95 | 34.5 | |
| Mondur ML | | | 36 |
| Lupranat MCI | | | |
| Mondur TD-80 | | | |
| Desmodur I | 40.95 | 34.5 | 36 |
| DBTDL | 0.02 | 0.02 | 0.02 |

Prior art by two-step process: All the prepolymers listed in table 9 were prepared using the method described below with only the relative amounts and specific types of reactants changed for each example. Desmophen S1015-55 (or PPG2000) and DMPA were added to a mixer reactor and heated with agitation up to 60° C. After the DMPA was completely dissolved, aromatic isocyanate was added to the mixture. When there was no exotherm, the mixer reactor temperature was kept stable at 75° C. during the reaction. After 2 hours for Mondur M and 4 hours for Mondur ML, aliphatic isocyanate, Desmodur I (isophorone diisocyanate, available from Bayer), and DBTDL were added to the mixture and continued to react at 75° C. The reaction was stopped when the NCO % reached the theoretically desired value. Then, the prepolymers were ready for dispersion.

TABLE 10
Dispersion Compositions

| Component | Wt. % |
|---|---|
| Prepolymer | 34.73 |
| TEA | 1.72 |
| DI Water | 60.68 |
| DeeFo 3000 | 0.05 |
| DI Water | 1.88 |
| EDA | 0.94 |
| | 100 |

Dispersion: Table 10 lists the formula for all prepolymer dispersions, the only difference for each PUD being the particular prepolymer used. TEA was added to mixer reactor under agitation, and allowed to mix for 10 minutes with the prepolymer. Then, DI water was added and the agitation rate was increased to 7000 rpm. DeeFo 3000 may be used to control foaming if necessary during the dispersion. After one hour, EDA pre-dissolved in DI water was added to the dispersion under agitation to eliminate the free NCO. The agitation was stopped when there was no residual % NCO left as shown by IR analysis, and all materials in mixer reactor were collected for future test.

Test results and discussion: 5 days after the PUDs were made, they were checked and the results are summarized in Table 11, in which the PUD from prepolymer G is named G′, from prepolymer H is named H′, and so on.

TABLE 11
Properties of the Polyurethane Dispersions 5 days after they were made
Dispersion samples

| G′ | H′ | I′ | J′ | K′ | L′ | M′ | N′ | O′ | P′ | Q′ |
|---|---|---|---|---|---|---|---|---|---|---|
| stable PUD | stable PUD | stable PUD | stable PUD | gel | sediment | sediment | sediment | sediment | sediment | gel |

| R′ | S′ | T′ | U′ | V′ | W′ | X′ | Y′ | Z′ | ZZ′ |
|---|---|---|---|---|---|---|---|---|---|
| partial gel | Gel | gel | gel | gel | gel | gel | gel | gel | gel |

As shown in Table 11, the inventive prepolymers from the formulations in Table 6 were made from two aromatic isocyanates with a one-step process. Stable PUDs were obtained from prepolymers G, H, I and J, while PUD from prepolymer K is a gel. The common characteristic of the prepolymers G, H, I and J is that isomeric mixture of aromatic isocyanate Lupranat MCI is used in its formulation.

The additional aromatic isocyanates used in prepolymer G and H, Mondur M and Mondur ML, are also isomeric mixtures of methylene bis (phenyl isocyanate). The combination of Lupranat MCI and the additional aromatic isocyanate in prepolymer G and H each has about 33% and about 30% by weight 4,4′-methylene bis (phenyl isocyanate), respectively. Surprisingly, stable PUDs can be formed from both prepolymers. In comparison, prepolymer B with about 45% by weight 4,4′-methylene bis (phenyl isocyanate) could not form a stable PUD.

The prepolymers from the formulations in Table 6 were made from two aromatic isocyanates with a two-step process. Lupranat MCI was used in all formulations. During the prepolymers preparation, the “additional” (d) aromatic polyisocyanates were added reacted first, then Lupranat MCI (inventive isomeric mixture (c)) was added into the reaction system to finish the reaction. None of the prepolymers formed stable PUD, regardless of the particular “additional” aromatic used e.g., Mondur M, Mondur ML or Mondur TD-80. Among them, all PUDs from prepolymers L, M, N, O and P became sediments, PUD from prepolymer Q became a gel.

A “reverse” two-step process was also tried to prepare the prepolymer by the formulation list in Table 7, in which the isomeric isocyanate mixture (Isocyanate A) (Lupranat MCI in this case) was added into reactor first, then the “additional (d) aromatic polyisocyanates were added, such as Mondur ML. After 5 days, the PUD R′ from this prepolymer was partially gelled.

In the prior art, stable PUD have been made by using both aromatic and aliphatic isocyanate, in which the prepolymers were made in solvents via one-step or two-step processes. After dispersion, the solvents were extracted by distillation. Prior art prepolymers were also prepared using the mixtures of aromatic and aliphatic isocyanates via one-step and two-step processes in bulk without any solvent. The formulations of these prepolymers are list in Tables 8 and 9. No stable PUD was able to be obtained from those prepolymers as indicated in Table 11 from S′ to ZZ′.

From these results, it has been found that stable PUD can be made without the aid of solvent by using a mixture of aromatic isocyanates, in which one aromatic isocyanate should be an isomeric mixture of diphenylmethane diisocyanate (MDI) wherein the weight percentage of 4,4′-methylene bis(phenyl isocyanate) (4,4′-MDI) is less than 37%, preferably less than 33%, and most preferably less than 3%. Optionally, but desirably, an additional aromatic isocyanate may also be added. The additional aromatic isocyanate may be any commercial aromatic isocyanate, such as Mondur M, Mondur ML and Mondur TD-80. Surprisingly, the additional aromatic isocyanates have to be added into the reaction system to react with polyol or polyols in essentially a one-step process in order to form stable polyurethane dispersions.

1. A method of making a polyurethane dispersion comprising a mixture of aromatic polyisocyanates comprising the steps of:
(1) forming a polyurethane prepolymer from a composition comprising:
a) at least one polyol;
b) at least one diol containing carboxyl functionality;
c) an isomeric mixture of diphenylmethyl diisocyanate comprising about 37% by weight or less of 4,4′-methylene bis (phenyl isocyanate); and optionally
d) at least one additional aromatic isocyanate; and
(2) combining the polyurethane prepolymer from step (1) with at least one neutralizing amine and water.

2. The method of claim 1, wherein step d) is not optional and steps c) and d) are performed in an essentially one-step process, being added within 45 minutes of each other after the polyol has begun to react.

3. The method of claim 1, further comprising adding at least one amine crosslinker in step (2).

4. The method of claim 1, wherein at least one polyol is selected from the group consisting of polyether polyols, polyester polyols, acrylic polyols, a polybutadiene polyols and combinations thereof.

5. The method of claim 1, wherein at least one diol containing carboxyl functionality is 2,2-dimethylolpropionic acid or 2,2-dimethylolbutanic acid.

6. The method of claim 1, wherein the isomeric mixture of diphenylmethyl diisocyanate comprises about 33% by weight or less of 4,4′-methylene bis (phenyl isocyanate).

7. The method of claim 1, wherein the isomeric mixture of diphenylmethyl diisocyanate comprises about 20% by weight or less of 4,4′-methylene bis (phenyl isocyanate).

8. The method of claim 1, wherein the isomeric mixture of diphenylmethyl diisocyanate comprises about 12% by weight or less of 4,4′-methylene bis (phenyl isocyanate).

9. The method of claim 1, wherein the molar ratio of the additional aromatic isocyanate in step d) to the isomeric mixture of step c) is less than about 65:35.

10. The method of claim 1, wherein the molar ratio of the additional aromatic isocyanate in step d) to the isomeric mixture of step c) is less than about 50:50.

11. The method of claim 1, wherein the molar ratio of the additional aromatic isocyanate in step d) to the isomeric mixture of step c) is less than about 35:65.

12. The method of claim 1, wherein the polyol is present in an amount of about 50% to about 95% by weight of the composition from which the polyurethane prepolymer is formed.

13. The method of claim 1, wherein the diol containing carboxyl functionality is present in an amount of about 1% to about 25% by weight of the composition from which the polyurethane prepolymer is formed.

14. The method of claim 1, wherein the isomeric mixture is present in an amount of about 3% to about 60% by weight of the composition from which the polyurethane prepolymer is formed.

15. The method of claim 1, wherein the neutralizing amine is present in a ratio of diol containing carboxyl functionality to neutralizing amine of about 1:0.35 to about 1:2.5.

16. The method of claim 1, wherein the polyurethane dispersion is free of added organic solvent.

17. A polyurethane prepolymer formed by reacting a composition comprising:
a) at least one polyol;
b) at least one diol containing carboxyl functionality;
c) an isomeric mixture of diphenylmethyl diisocyanate comprising about 37% by weight or less of 4,4′-methylene bis (phenyl isocyanate); and optionally
d) at least one additional aromatic isocyanate.

18. The polyurethane prepolymer of claim 17, wherein the isomeric mixture of diphenylmethyl diisocyanate comprises about 33% by weight or less of 4,4′-methylene bis (phenyl isocyanate).

19. The polyurethane prepolymer of claim 17, wherein the isomeric mixture of diphenylmethyl diisocyanate comprises about 20% by weight or less of 4,4′-methylene bis (phenyl isocyanate).

20. The polyurethane prepolymer of claim 17, wherein the isomeric mixture of diphenylmethyl diisocyanate comprises about 12% by weight or less of 4,4′-methylene bis (phenyl isocyanate).

21. The method of claim 17, wherein the molar ratio of the additional aromatic isocyanate in step d) to the isomeric mixture of step c) is less than about 65:35.

22. The method of claim 17, wherein the molar ratio of the additional aromatic isocyanate in step d) to the isomeric mixture of step c) is less than about 50:50.

23. The method of claim 17, wherein the molar ratio of the additional aromatic isocyanate in step d) to the isomeric mixture of step c) is less than about 35:65.

24. A polyurethane prepolymer formed from an isomeric mixture of diphenylmethyl diisocyanate comprising a polymer segment formed from no more than about 37% by weight 4,4′-methylene bis (phenyl isocyanate) isomer.

25. The polyurethane prepolymer of claim 24 wherein the isomeric mixture of diphenylmethyl diisocyanate comprises about 33% by weight or less of 4,4′-methylene bis (phenyl isocyanate).

26. The polyurethane prepolymer of claim 24, wherein the isomeric mixture of diphenylmethyl diisocyanate comprises about 20% by weight or less of 4,4′-methylene bis (phenyl isocyanate).

27. The polyurethane prepolymer of claim 24, wherein the isomeric mixture of diphenylmethyl diisocyanate comprises about 12% by weight or less of 4,4′-methylene bis (phenyl isocyanate).

28. A polyurethane dispersion comprising:
a) an aqueous medium; and
b) polyurethane prepolymer particles dispersed within the aqueous medium, wherein the polyurethane prepolymer particles are formed from a composition comprising an isomeric mixture of diphenylmethyl diisocyanate and at least one additional aromatic isocyanate and the composition comprises no more than about 37% by weight of a polymer segment formed from 4,4′-methylene bis (phenyl isocyanate).

29. The polyurethane dispersion of claim 28, wherein the isomeric mixture of diphenylmethyl diisocyanate comprises about 33% by weight or less of 4,4′-methylene bis (phenyl isocyanate).

30. The polyurethane dispersion of claim 28, wherein the isomeric mixture of diphenylmethyl diisocyanate comprises about 20% by weight or less of 4,4′-methylene bis (phenyl isocyanate).

31. The polyurethane dispersion of claim 28, wherein the isomeric mixture of diphenylmethyl diisocyanate comprises about 12% by weight or less of 4,4′-methylene bis (phenyl isocyanate).

32. The polyurethane dispersion of claim 28, wherein the molar ratio of the additional aromatic isocyanate in step d) to the isomeric mixture of step c) is less than about 65:35.

33. The polyurethane dispersion of claim 28, wherein the molar ratio of the additional aromatic isocyanate in step d) to the isomeric mixture of step c) is less than about 50:50.

34. The polyurethane dispersion of claim 28, wherein the molar ratio of the additional aromatic isocyanate in step d) to the isomeric mixture of step c) is less than about 35:65.

35. A polyurethane coating formed from the polyurethane dispersion of claim 1.

36. An adhesive formed from the polyurethane dispersion of claim 1.

37. A sealant formed from the polyurethane dispersion of claim 1.

38. A method of mating two substrates comprising applying the polyurethane dispersion of claim 1 to a substrate surface, mating another substrate therewith such that the polyurethane dispersion is in contact with both substrates and allowing the polyurethane dispersion to cure or dry.

39. A method of coating comprising applying the polyurethane dispersion of claim 1 to a substrate and allowing it to dry.

40. A method of coating comprising applying the polyurethane dispersion of claim 1 to a substrate and allowing it to cure.

41. The method of claim 1 further comprising blending the polyurethane prepolymer from step (1) with a monomer, a polymer, or any combination thereof.

42. The method of claim 1 further comprising copolymerizing the polyurethane prepolymer from step (1) with a monomer, a polymer, or any combination thereof.
